(19) United States
(12) Patent Application Publication
(10) Pub. No.: US 2026/0117586 A1
(43) Pub. Date: Apr. 30, 2026

(54) Blind Attachment Arrangement and a Blind Assembly Comprising a Window Blind Attachment Arrangement

(71) Applicant: Tropical Blinds Limited, Sidcup (GB)

(72) Inventor: Martin Skiggs, Sidcup (GB)

(21) Appl. No.: 19/365,403

(22) Filed: Oct. 22, 2025

(30) Foreign Application Priority Data
Oct. 24, 2024 (GB) GB2415661.4

(51) Int. Cl. E06B 9/266

(52) U.S. Cl. CPC E06B 9/266

(57) ABSTRACT

A blind attachment arrangement comprising at least one attachment guide adhesively attachable to a window, door, or the like, at least one guide-side attachment means associated with the attachment guide, at least one blind-side attachment means associated with a blind, wherein the at least one guide-side and blind-side attachment means are corresponding attachment means sized, dimensioned, and positioned to selectably engage one another to form an attachment therebetween and resultantly secure a blind to a window, door, or the like.

### PRIORITY OF INVENTION

This application claims priority to UK Patent Application No. GB2415661.4, filed 24 Oct. 2024.

### FIELD OF THE INVENTION

This invention relates to a blind attachment arrangement and a blind assembly comprising the same.

### BACKGROUND OF THE INVENTION

Blinds are a popular choice when considering coverings for windows, doors, or the like. Traditionally, blinds have been built in a bespoke manner and installed professionally and permanently given that windows tend to be of various shapes and sizes. Therefore, providing a standardised and/or easily installed blind solution is difficult. Solutions exists whereby brackets are provided which are installed behind the beading of a window, and the blinds are then installed onto said brackets via an additional bracketing component installed on the blinds itself. However, such solutions still relay on a level of skill and judgement in terms of placement of the brackets. Moreover, disturbance of the beading of a window may also void any available warranty, and may damage the beading or glass itself. In addition, as window size varies, customers ordering self-install blinds must measure various dimensions accurately in order that the resulting blinds suitably fits the desired window. It can often be difficult for some customers to achieve accurate measurements across all dimensions, resulting in an imperfectly fitting blinds.

It is desirable to provide a blind attachment arrangement which permits easy install, reduces impact to the beading or other components of a window, door or the like, and reduces the number of measurements required in order to achieve a well-fitting blind.

### SUMMARY OF THE INVENTION

According to the invention there is provided a blind attachment arrangement comprising: at least one attachment guide adhesively attachable to a window, door, or the like; at least one guide-side attachment means associated with the attachment guide; at least one blind-side attachment means associated with a blind; wherein the at least one guide-side and blind-side attachment means are corresponding attachment means sized, dimensioned, and positioned to selectably engage one another to form an attachment therebetween and resultantly secure a blind to a window, door, or the like, wherein the blind attachment arrangement comprises a depth adjustment mechanism disposed between the attachment guide and blind configured such that one of the attachment guide or blind is securable relative to the respective other of the attachment guide or blind at a plurality of depthwise locations.

Advantageously, a blind may be attached to a window, door, or any other such suitable opening without the requirement to place brackets behind the beading of said window, door or the like which may damage said beading and potentially void any warranty.

Ideally, the blind attachment arrangement comprises a depth adjustment mechanism disposed between the attachment guide and blind configured such that one of the attachment guide or blind is securable relative to the respective other of the attachment guide or blind at a plurality of depthwise locations.

Ideally, the blind attachment arrangement comprises a depth adjustment mechanism disposed between the blind side and guide side attachment means configured such that one of the attachment guide or blind is securable relative to the respective other of the attachment guide or blind at a plurality of depthwise locations.

Ideally, the depth adjustment mechanism comprises corresponding securing features disposed between the blind and attachment guide.

Ideally, one of the attachment guide or blind is securable relative to the respective other of the attachment guide or blind at a plurality of depthwise locations.

Preferably, the blind is securable relative to the attachment guide at a plurality of depthwise locations.

Preferably, the guide-side attachment means and blind-side attachment means comprise the corresponding securing features disposed therebetween.

Ideally, one of the guide-side attachment means or blind-side attachment means is securable relative to the respective other of the guide-side attachment means or blind-side attachment means at a plurality of depthwise locations.

Preferably, the guide-side attachment means is securable relative to the blind-side attachment means at a plurality of depthwise locations.

Ideally, the securing features disposed between the guide-side attachment means and blind-side attachment means permit releasable securing of these components.

Ideally, the securing features disposed between the guide-side attachment means and blind-side attachment means permit releasable securing of these components at a plurality of depthwise locations.

Preferably, one of the blind or the attachment guide comprises a first set of securing features having a plurality of securing formations, the respective other of the blind and attachment guide comprising a second securing feature configured for receipt into a selected one of said plurality of first securing features securing the blind and attachment guide together.

Advantageously, the attachment between the blind and attachment guide can be to various depthwise extents based upon which one of the plurality of securing formations the second securing feature is received into.

Preferably, the second securing feature is moved along the plurality of securing formations of the first set of securing features by aligning the blind with the attachment guide such that the blind side and guide side attachment means are engagable and pushing the blind towards the attachment guide to increasingly engage the blind side and guide side engagement means, said increasing engagement causing the second securing feature to move sequentially along the plurality of securing formations of the first set of securing features.

Ideally, once the blind contacts at least a portion of a window frame, the second securing feature ceases to move further along the plurality of securing formations of the first set of securing features and is retained in whichever securing formation it is at that point received within until the blind is desired to be removed by pulling the blind away from the attachment guide.

Advantageously, the blind may be attached to the window, door, or the like without need for consideration of the depth to which the glazing in the window, door or the like sits back from the frame thereof as the guide-side and blind side attachment means engage and one can be forced towards the other until the blind contacts the frame of the window, door or the like, at which point the guide-side and blind-side attachment means are releasably secured together.

Advantageously, an end user need not measure the glazing depth to order a correctly fitting blind, nor does the manufacturer of the presently claimed blinds need to provide brackets or clips of varying sizes which compensate for varying glazing depths.

Ideally, the attachment guide is an elongate member.

Preferably, the attachment guide comprises a first side configured for adhesive attachment to a window, door, or the like.

Ideally, the attachment guide comprises a second side comprising at least a portion of the at least one guide-side attachment means.

Preferably, the attachment guide is an elongate member sized to extend all or part way across the window, door, or the like in a generally horizontal manner.

Ideally, the attachment guide is sized to extend substantially all the way across the window, door or the like in a generally horizontal manner.

Preferably, the attachment guide is sized to extend substantially all the way across the visible glazing portion of window, door or the like in a generally horizontal manner.

Preferably, the blind attachment arrangement comprises at least two attachment guides.

Ideally, one attachment guide is locatable at or about a top end of a window, door or the like, and one attachment guide is locatable at or about a bottom end of said window, door or the like.

Alternatively, the attachment guide is an elongate member sized to extend all or part way across the window, door or the like in a generally vertical manner, or can take any other form or orientation which permits the attachment guide to suitably attach to a window, door or the like and adequately support a blind attached thereto.

Preferably, the at least one guide-side attachment means is formed integrally with, is attachable to, or is configured to form part of the at least one first attachment guide.

Ideally, the at least one attachment guide is a multi-section elongate attachment guide.

Preferably, the multi-section elongate attachment guide comprises at least one guide-side attachment means and at least one guide section attachable thereto.

Preferably, the multi-section elongate attachment guide comprises a plurality of guide sections.

Ideally, the guide sections are attachable to each other and/or to the at least one guide-side attachment means to form the attachment guide.

Preferably, the at least one guide-side attachment means comprises a guide-side attachment portion which is attachable to one or more guide sections.

Ideally, the guide-side attachment portion is attachable to one or more guide sections in an end to end arrangement such that a plurality of guide sections and at least one the guide-side attachment portion are attachable to form an elongate attachment guide.

Preferably, the guide-side attachment portion is attachable to one or more guide sections in an end to end arrangement such that a plurality of guide sections and at least one the guide-side attachment portion are attachable sequentially in a linear arrangement to form an elongate attachment guide.

Alternatively, the one or more guide-side attachment means are formed integrally of the attachment guide or may be attached in any other reasonable manner to the attachment guide as would be appreciated by the skilled person.

Ideally, first and second guide-side attachment portions are provided.

Preferably, the attachment guide comprises, in sequential order, a first guide section, the first guide-side attachment portion, a second guide section, the second guide-side attachment portion, and a third guide section attached together in a linear arrangement such that a guide arrangement comprising two spaced apart guide-side attachment portions is formed.

Ideally, one of the guide-side attachment means or the blind-side attachment means comprises a male attachment member and the other of the guide-side attachment means or the blind-side attachment means comprises a corresponding female attachment member configured to receive the male attachment member.

Preferably, the guide-side attachment means comprises a male attachment member which protrudes from the guide-side attachment means.

Ideally, the male attachment member protrudes from the guide attachment means in a direction away from a blind facing surface of the attachment guide, the blind facing surface being the surface opposing a surface of the attachment guide attached to a window when in use.

Preferably, the male attachment member comprises at least one engagement flange.

Ideally, the at least one engagement flange projects, in use, away from the attachment guide, and generally away from the window to which said attachment guide is attached

Preferably the male attachment member comprises two engagement flanges.

Ideally, the guide-side attachment means comprises first and second attachment guide engagement portions.

Preferably, the first and second attachment guide engagement portions are configured to connect the guide-side attachment means between two sections of the attachment guide in a liner fashion.

Ideally, the male attachment member extends generally perpendicular to the attachment guide engagement portions.

Preferably, the at least one blind-side attachment means is formed integrally with, is attachable to, or is configured to form part of a blind.

Ideally, the at least one blind-side attachment means comprises a blind attachment portion.

Preferably, the blind attachment portion comprises a female attachment member.

Ideally, the female attachment member is formed for receiving at least a portion of the male attachment member of the guide attachment means.

Preferably, the female attachment member comprises a cavity into which at least a portion of the male attachment member is receivable.

Ideally, the blind-side attachment means comprises an insert member formed for insertion into an aperture formed in a window facing surface of a blind.

Preferably, the insert member defines a cavity therein.

Ideally, when the insert member is inserted into the aperture in the blind the cavity extends inwardly, into the blind from the window, door, or the like facing surface of the blind.

The window facing surface of the blind is the surface which faces the window, door, or the like when the blind is attached thereto.

Preferably, the cavity is sized, dimensioned, and positioned to receive at least a portion of the male attachment member.

Ideally, securing features are disposed between the male and female attachment members such that the male attachment member is insertable into and securable relative to the female attachment means at a plurality of depthwise locations.

The term depthwise as used herein is intended to refer to a depthwise direction defined by an axis extending generally perpendicular to the plane of the window glazing, from internal of a window, door or the like, to external thereof. Put another way, the depthwise dimension is that which would typically be understood in the context of a window frame, this dimension describing the depth or thickness of the frame. Therefore, for example, in stating that the male attachment member is insertable into and securable relative to the female attachment means at a plurality of depthwise locations, this is intended to convey that the male attachment member is insertable to various locations in a direction which is towards or away from the window relative to the female attachment member. In addition, where “glazing depth” or “depth of the glazing” is referred to, this generally refers to the depth the glazing is set-back from the inward facing surface of the frame portion of the window frame.

Ideally, the securing features are corresponding securing features.

Preferably, at least one of the male or female engagement members comprises a series of increasingly depthwise dispersed securing features and the respective other of the male or female engagement members comprises at least one securing feature sized and dimensioned for releasable securing in one of said depthwise dispersed securing features.

Preferably, the corresponding securing features comprise at least one series of female securing features having a plurality of female receiving formations locatable on the blind attachment means, each said formation being located in a progressively depthwise manner; and at least one male securing formation locatable on the guide attachment means formed for selectable receipt into one of the female receiving formations.

Advantageously, the blind may be attached to the window, door, or the like without need for consideration of the depth to which the glazing in the window, door or the like sits back from the frame thereof as the male attachment member is inserted into the female attachment member and continues to be inserted until a blind associated with the blind side attachment means contacts the frame of the window, door or the like, at which point the male and female attachment members are releasably secured together. This results in no requirement for an end user of the blind to measure for depth of glazing, nor for this to be taken account of in manufacturing. Moreover, the manufacturer does not need to make and supply brackets, clips, or the like in various sizes to compensate for varying glazing depth.

Ideally, the female securing formations are a series of securing indentations or channels formed on an internal wall of the female attachment member.

Preferably, the at least one male securing formation being a projection formed on the male attachment member.

Ideally, the at least one male securing formation is a projection formed on the at least one flange of the male attachment member.

Preferably, the projection of the male attachment member is receivable into one of the securing channels.

Ideally, the particular securing channel the projection is received into is dictated by how far depthwise the blind is pushed towards the attachment guide.

Preferably, a first series of female securing channels is formed on a first internal wall of the cavity.

Ideally, a second series of female receiving channels is formed on a second internal wall of said cavity opposing said first wall thereof.

Preferably, the male attachment member comprises first and second projections.

Ideally, the first projection is located on a first flange of the male attachment member.

Ideally, in use when the guide-side and blind-side attachment means are being engaged, the first projection of the first flange of the male attachment member faces the first series of female securing channels.

Preferably, the second projection is located on a first flange of the male attachment member.

Ideally, in use when the guide-side and blind-side attachment means are being engaged, the second projection of the second flange of the male attachment member faces the second series of female securing channels.

Preferably, the projections are configured to engage said respective securing channels as the male attachment member is inserted into the cavity.

Ideally, the at least one attachment guide is adhesively attachable to a window, door, or the like and is not required to extend behind beading or any other such glass retention feature in order to provide a secure attachment which permits a blind to be installed thereto.

Preferably, the at least one attachment guide is adhesively attachable to the glazing of a window, door, or the like.

According to a second aspect of the invention there is provided a blind assembly comprising a blind and a blind attachment arrangement, the blind attachment arrangement comprising: at least one attachment guide adhesively attachable to a window, door, or the like; at least one guide-side attachment means associated with the attachment guide; at least one blind-side attachment means associated with the blind; wherein the at least one guide-side and blind-side attachment means are corresponding attachment means sized, dimensioned, and positioned to selectably engage one another to form an attachment therebetween and resultantly secure the blind to a window door, or the like, wherein the blind attachment arrangement comprises a depth adjustment mechanism disposed between the attachment guide and blind configured such that one of the attachment guide or blind is securable relative to the respective other of the attachment guide or blind at a plurality of depthwise locations.

According to a third aspect of the invention there is provided a method of manufacturing a blind assembly comprising the steps of: providing at least one attachment guide adhesively attachable to a window, door, or the like and sizing said attachment guide to fit said window, door, or the like; forming at least one guide-side attachment means associated with the attachment guide; forming at least one blind-side attachment means associated with the blind; wherein the at least one guide-side and blind-side attachment means are corresponding attachment means sized, dimensioned, and positioned to selectably engage one another to form an attachment therebetween and resultantly secure the blind to a window door, or the like, wherein the blind attachment arrangement comprises a depth adjustment mechanism disposed between the attachment guide and blind configured such that one of the attachment guide or blind is securable relative to the respective other of the attachment guide or blind at a plurality of depthwise locations.

Optionally, the attachment guide may be a clip or bracket.

### BRIEF DESCRIPTION OF THE DRAWINGS

An embodiment of the invention is now described by way of example and with reference to the accompanying drawings in which:

FIG. 1 is a first isometric view showing an attachment guide for attachment to a window/door or the like, and a blind rail, the blind rail and attachment guide having an attachment arrangement therebetween, and the blind and attachment guide being in a non-attached condition.

FIG. 2 is second isometric view of FIG. 1;

FIG. 3 is an isometric view of the FIG. 1 attachment guide and blind rail showing the attachment guide and blind rail in an attached condition.

FIG. 4 is a side view of the attachment guide and blind rail of FIG. 1;

FIG. 5 is a front isometric view of a guide-side attachment means of the blind attachment arrangement of FIG. 1;

FIG. 6 is a rear isometric view of a guide-side attachment means of the blind attachment arrangement of FIG. 1;

FIG. 7 is a bottom view of the guide-side attachment means of FIG. 5;

FIG. 8 is a front view of the guide-side attachment means of FIG. 5;

FIG. 9 is a side view of the guide-side attachment means of FIG. 5;

FIG. 10 is a rear view of the guide-side attachment means of FIG. 5;

FIG. 11 is a plan view of the guide-side attachment means of FIG. 5;

FIG. 12 is a front isometric view of a blind-side attachment means of the blind attachment arrangement of FIG. 1;

FIG. 13 is a rear isometric view of a blind-side attachment means of the blind attachment arrangement of FIG. 1;

FIG. 14 is a side view of the blind-side attachment means of FIG. 12;

FIG. 15 is a rear view of the blind-side attachment means of FIG. 12;

FIG. 16 is a plan view of the blind-side attachment means of FIG. 12;

FIG. 17 is a front view of the blind-side attachment means of FIG. 12;

FIG. 18 is front view of a cap element of the guide-side attachment means of FIG. 5;

FIG. 19 is a side view of the cap element of FIG. 18;

FIG. 20 is an isometric view of the cap element of FIG. 18;

FIG. 21 is front view of an end cap of an attachment guide of the blind attachment arrangement of FIG. 1;

FIG. 22 is a side view of the end cap of FIG. 21;

FIG. 23 is an isometric view of the end cap of FIG. 21;

### DETAILED DESCRIPTION OF THE DRAWINGS

The present teaching will now be described with reference to an exemplary blind attachment arrangement and blind assembly comprising said blind arrangement. It will be understood that the exemplary blind attachment arrangement and blind assembly are provided to assist in an understanding of the present teaching and are not to be construed as limiting in any fashion. Furthermore, elements or components that are described with reference to any one Figure may be interchanged with those of other Figures or other equivalent elements without departing from the spirit of the present teaching.

Referring now to the Figures there is illustrated a blind assembly 10 comprising a blind attachment arrangement 11, 12, 13. The blind attachment arrangement 11, 12, 13 has at least one attachment guide 13 adhesively attachable to a window, door, or the like. It should be understood that, for brevity, the term window may be utilised herein, however the blind and attachment arrangement described herein may be utilised for attachment of a blind to any suitable opening in a building or other such structure and as such the term window should be construed to encompass such features. In addition, it should be noted that the drawings depict only the blind rail 16 without blind attached. However it should be understood that the presently described invention may be utilised with any blind rail to hold blinds of different types such as but certainly not limited to venetian blinds, roller blinds, vertical blinds, or the like and as such the particular blind rail 16 of the drawings should not be construed as limiting in this regard. In a preferred embodiment, the attachment guide 13 is an elongate member having a first side 14 configured for adhesive attachment to a window. In the preferred embodiment, the attachment guide 13 is attached to the visible portion of the window glazing utilising glass tape as is commonly known in the field. In the preferred embodiment the tape utilised is commercially available tape offered by Tesa®. The attachment guide 13 sized to extend substantially all the way across a window in a generally horizontal manner, preferably substantially all of the way across the visible glazing portion of the window. In one embodiment, the blind attachment arrangement 11, 12, 13 comprises a single attachment guide 13 attached generally at the upper portion of the window, and preferably extending along the upper width-wise dimension of the window glazing. In this manner a blind rail 16 and associated blind may be attached to a window at its upper end as would be typical practice for blinds. In an alternative embodiment, the blind attachment arrangement 11, 12, 13 may comprise two attachment guides 13, one attachment guide 13 being located at or about a top end of a window, and one attachment guide 13 being locatable at or about a bottom end of said window such that a blind 16 attached thereto is supported at both its top and bottom ends. In the Figures, only one attachment guide 13 is shown in order to aid clarity, however a similar arrangement may be established at both the top and bottom of the window to achieve the above described double attachment guide 13 arrangement. It should be noted that whilst having one attachment guide at the top and one at the bottom extending horizontally substantially across the glazing is the preferred embodiment, the description of the extent, direction, and number of attachment guides should not be construed as limiting. For example, the attachment guides need not necessarily be elongate, need not extend fully across the glazing, could extend vertically or at positions between horizontal and vertical, and could vary in number depending on window size. In addition, an embodiment is envisages wherein the blind attachment arrangement 11, 12, 13 comprises a single top attachment guide 13 attached generally at the upper portion of the window, and preferably extending along the upper width-wise dimension of the window glazing, however additional side guides are provided along the vertical sides of the window which extend in a direction from the bottom of the window towards the top thereof and optionally attach to the single attachment guide 13. The vertical side attachment guides may act to provide additional attachment points to the window such that the top single attachment guide 13 does not become detached from the window, this being of particular importance where the blind being retained is of significant weight. Essentially, the attachment guides can take any other form or orientation which permits the attachment guide to suitably attach to a window and adequately support a blind attached thereto.

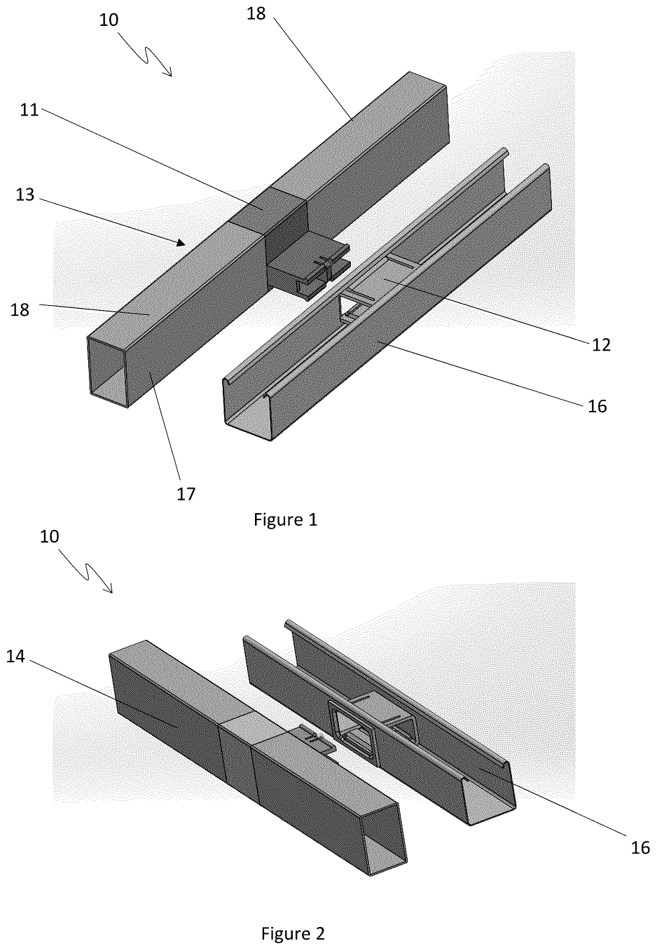

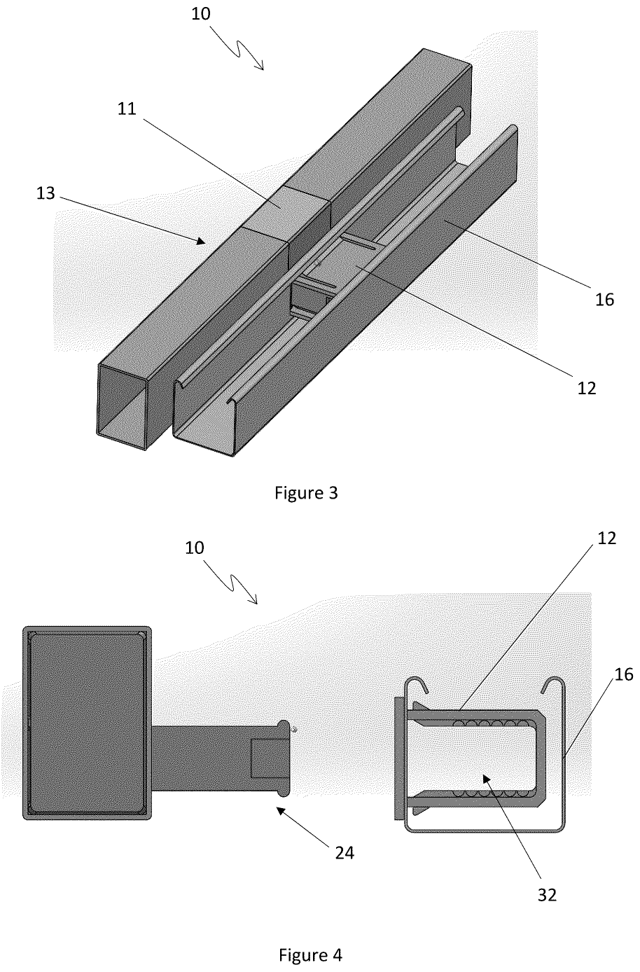

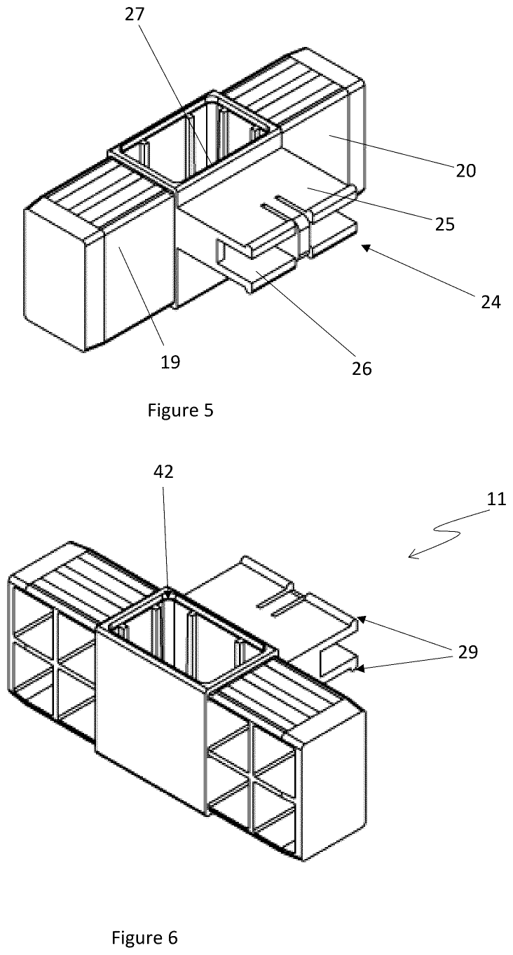

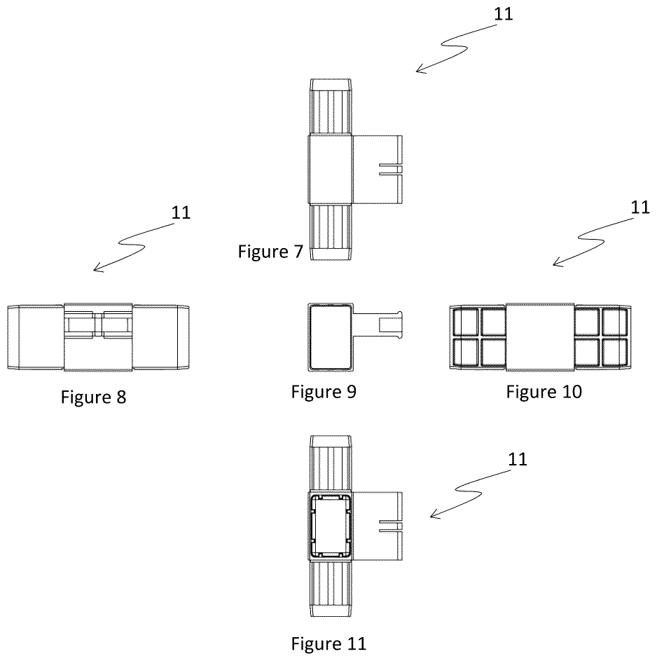

The attachment arrangement 11, 12, 13 also comprises at least one guide-side attachment feature 11 associated with the attachment guide 13. The attachment guide 13 comprises a second side 17 opposing the first side 14 for adhesive attachment to a window, the second side 17 comprising at least a portion of the at least one guide-side attachment feature 11. In the embodiment of the drawings, the attachment guide 13 comprises only a single guide-side attachment features 11 disposed centrally on the attachment guide 13. In one embodiment, the attachment guide 13 comprises two guide-side attachment features 11 in a spaced apart relationship on the attachment guide 13. In a preferred embodiment, the attachment guide is a multi-part attachment guide 13. In the embodiment of FIGS. 1 to 4, the multi-part attachment guide 13 comprises two guide sections 18 and a single guide-side attachment feature 11. However, should be appreciated that in an alternative embodiment the multi-part attachment guide 13 may comprise three guide sections 18 attached to two guide-side attachment features 11. The three guide sections 18 and two guide side attachment features 11 are attached together in a linear end to end arrangement to form the resulting elongate attachment guide. The guide side attachment features 11 comprise first and second attachment guide engagement portions 19, 20. The guide sections 18 are channel sections, preferably box or rectangular channel sections, having a central cavity 21. The first and second attachment guide engagement portions 19, 20 are sized and dimensioned such that they are insertable into the cavity 21 of the guide sections 18, forming an attachment therebetween. Preferably, a friction fit is provided between the first and second attachment guide engagement portions 19, 20 and the guide sections 18. As can be seen in FIG. 1, the first and second attachment guide engagement portions 19, 20 are configured to connect the guide-side attachment means between two sections 18 of the attachment guide in a liner fashion. In the preferred embodiment, as noted above, the attachment guide comprises two guide-side attachment features 11 joined together at their inner attachment guide engagement portions 19 via a common central guide section. Each of the two guide-side attachment features 11 are also joined at their outer guide engagement portions 20 to outer guide sections. This forms a five part attachment guide 13 which is sized to suitably span the glazing of the window to which it is to be attached and to align the two guide-side attachment features 11 which corresponding engagement features which are located on a blind, as will be further discussed below. The positioning of the guide-side attachment features 11 relative to the widthwise span of the glazing of the window can be dictated by choosing the lengths of the central and end guide sections accordingly. Put differently, the attachment guide 13 comprises, in sequential order, a first end guide section, a first guide-side attachment feature 11, a common central guide section, the second guide-side attachment feature 11, and a second end guide section attached together in a linear arrangement such that a guide arrangement comprising two spaced apart guide-side attachment portions is formed. It should be understood that the preceding description of a five part attachment guide 13 is not intended to be limiting. The attachment guide may comprise more or fewer guide sections 18, and may incorporate additional guide-side attachment features 11, for example where large windows are concerned and attachment at additional points is desirable. Moreover, the guide-side attachment features 11 may equally be integrally formed with the remainder of the attachment guide 13, or may be attached thereto in a different manner as would be well within the knowledge of the skilled person. The guide-side attachment feature 11 comprises a male attachment member 24 which protrudes from the guide-side attachment feature 11. The male attachment member 24 protrudes from the guide-side attachment feature 11 in a direction away from a blind facing surface 17 of the attachment guide 13, the blind facing surface being the surface opposing the surface 14 of the attachment guide 13 adhesively attached to a window when in use. As can be best seen in FIGS. 5 to 11, in a preferred embodiment the male attachment member 24 comprises two engagement flanges 25, 26 which project, in use, away from the blind facing surface 17 of the attachment guide 13 in a generally perpendicular fashion relative to the longitudinal direction of the attachment guide 13. The engagement flanges 25, 26 resultantly project, in use, generally away from a window to which said attachment guide may be attached, and towards a blind to be attached to said window. As can be seen in FIG. 5, the engagement flanges 25, 26 project from a main body portion 27 of the guide-side attachment feature 11, and generally perpendicular to the attachment guide engagement portions 19, 20.

As noted above, the guide-side attachment feature 11 is formed to engage with a corresponding blind side attachment feature 12 associated with a blind rail 16. In the preferred embodiment, two blind-side attachment features 12 are provided which are located to correspondingly engage with the two above described guide-side attachment features 11. By this, it is meant that the blind-side attachment features 12 are located on the blind rail 16 such that placement of the blind rail 16 on a window to which the attachment guide 13 has been attached aligns the blind-side attachment features 12 with the guide side attachment features 11, such that the attachment features 11, 12 may be engaged to secure the blind rail 16 and any associated blind to the window via the attachment guide 13. Advantageously, a blind may be attached to a window, door, or any other such suitable opening without the requirement to place brackets behind the beading of said window, door or the like which may damage said beading and potentially void any warranty.

One of the attachment guide 13 or blind rail 16 is securable relative to the respective other of the attachment guide 13 or blind rail 16 at a plurality of depthwise locations. In a preferable embodiment as is shown in the figures, the attachment guide 13 and blind rail 16 comprise corresponding securing features 28, 29 disposed therebetween permitting the blind rail to be securable relative to the attachment guide at a plurality of depthwise locations. In the preferred embodiment of the drawings, the guide-side attachment features 11 and blind-side attachment features 12 comprise the corresponding securing features 28, 29 disposed therebetween. Resultantly, one of the guide-side attachment feature 11 or blind-side attachment feature 12 is securable relative to the respective other of the guide-side attachment feature 11 or blind-side attachment feature 12 at a plurality of depthwise locations. In the most preferred embodiment, the guide-side attachment feature 11 is releasably securable relative to the blind-side attachment feature 12 at a plurality of depthwise locations. Advantageously, the blind rail 16 may be attached to the window without need for consideration of the depth to which the glazing in the window sits back from the inner surface of the frame thereof as the guide-side and blind side attachment features 11, 12 engage and the blind rail 16 can then be forced towards the attachment guide until a portion of the blind 16 contacts the frame of the window, at which point the guide-side and blind-side attachment features 11, 12 are releasably secured together.

As noted above, the guide-side attachment feature 11 is formed to engage with the corresponding blind side attachment features 12 associated with a blind rail 16. Again, in a preferred embodiment the blind rail is provided with two blind-side attachment features 12 each of which engage with a guide side attachment feature 11. The blind rail and associated blind is manufactured to size in order to fit a target window and the blind-side attachment features 12 are located on the blind rail 16 at positions such that they align with the positions of the guide-side attachment features 11. To this end, the blind-side attachment features 12 are spaced apart on the blind rail 16 by the same distance as the guide-side attachment features 11 are spaced apart when said guide-side features 11 are assembled or formed into the attachment guide 13. In a preferred process for determining positioning of the guide-side and blind-side attachment features 11, 12, a standard positioning of the blind-side attachment features 12 is determined, this preferably being a distance inward, toward the centre of the blind rail 16, as measured from the from the vertical side edges of the blind to the centre of the blind-side attachment features 12. The two blind-side attachment features 12 on each rail 16 are placed at this standardised distance, one from one vertical side of the blind 16 and one from the opposing vertical side of the blind 16. In an example embodiment this distance may be between approximately 80 mm and 130 mm from the vertical sides of the blind 16. The attachment guide 13 is then manufactured based on the known positioning of the blind-side attachment features 11 by choosing a length of the common central guide section and the end guide sections which space and position the guide-side attachment features 11 to match the spacing and position of the blind-side attachment features 12 when the blind rail 16 is orientated and positioned to be mounted to the attachment guide 13.

Given that the positioning of the blind-side attachment features 12 is known and is constant relative to the vertical side surface of the blind 16, the end guide sections may also have a known and constant length, with the length of the central guide section being dictated by remaining length between the two guide-side attachment features 11 required to span the width of the glazing of the window when the known length of the two end guide sections and two guide-side attachment features 11 are accounted for.

The at least one blind-side attachment feature 12 can be formed integrally with, is attachable to, or is configured to form part of the blind rail 16. In the preferred embodiment as shown in the Figures, the blind side attachment feature 12 is an insert 12. An aperture is formed in the blind rail 16 to receive the insert 12. The insert comprises securing ribs 38 which are spaced apart from a front lip 39 of the insert such that the edge of the aperture formed in the blind rail 16 for receiving the insert 12 is retained between the securing ribs 38 and the front lip 39 when the insert 12 is installed into said aperture. The insert comprises a female attachment member 32 in the form of a cavity 32 into which the male attachment member 24, or at least a portion thereof, is receivable. When the insert 12 is inserted into the aperture in the blind 16 the cavity 32 extends inwardly, into the blind rail 16 from the window facing surface of the blind rail 16, the window facing surface of the blind rail 16 being the surface which faces the window when the blind rail 16 is attached thereto. The cavity is sized, dimensioned, and positioned to receive at least a portion of the male attachment member 24.

It should be noted that the Figures describe a specific embodiment of a male and female attachment arrangement, however it should be noted that the skilled person would be able to implement alternative male and female attachment arrangements and therefore the embodiment of the Figures is not intended to be limiting. Moreover, while the present invention is generally described in terms of the blind rail 16 comprising the female attachment member and the attachment guide 13 comprising the male attachment member, the skilled person would clearly be able to implement the invention in the reverse manner, wherein the blind rail 16 comprises the male attachment member and the attachment guide 13 comprises the female attachment member. Therefore, the embodiment of the Figures is not intended to be limiting in this regard. In addition, the skilled person would be able to implement alternative attachment arrangements that fall outside of the definition of “male and female” and as such these alternatives are intended to be within the scope of the present invention.

The securing features 28, 29 are disposed between the male and female attachment members 24, 32 such that the male attachment member 24 is insertable into and securable relative to the female attachment member 32 at a plurality of depthwise locations. The term depthwise as used herein is intended to refer to a depthwise direction defined by an axis extending generally perpendicular to the plane of the window glazing, from internal of a window, door or the like, to external thereof. Put another way, the depthwise dimension is that which would typically be understood in the context of a window frame, this dimension describing the depth or thickness of the frame. Therefore, for example, in stating that the male attachment member 24 is insertable into and securable relative to the female attachment member 32 at a plurality of depthwise locations, this is intended to convey that the male attachment member 24 is insertable to various degrees in a direction which is towards or away from the window relative to the female attachment member 32 and is securable at various positions within this range of depthwise movement.

The securing features 28, 29 are corresponding securing features. In the embodiment of the Figures, the female engagement member 32 comprises a series of increasingly depthwise dispersed securing features 28 and the male engagement member 32 comprises at least one securing feature 29 sized and dimensioned for releasable securing in one of said depthwise dispersed securing features 28. As can best be seen in FIG. 13 in conjunction with FIG. 5, the corresponding securing features 28, 29 comprise at least one series of female securing features 28 having a plurality of generally identical female receiving formations 33, each said formation being located in a progressively depthwise manner. The at least one male securing formation 29 is sized and dimensioned for selectable receipt into one of the female receiving formations 33.

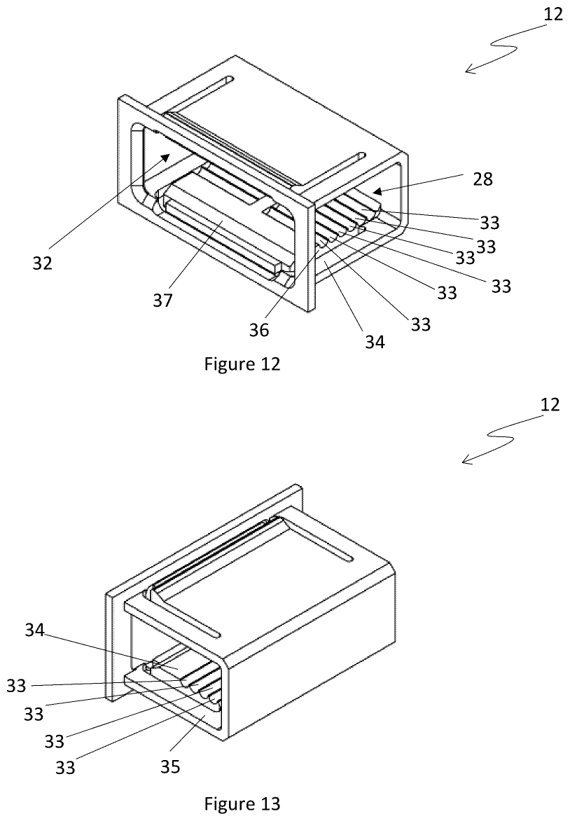

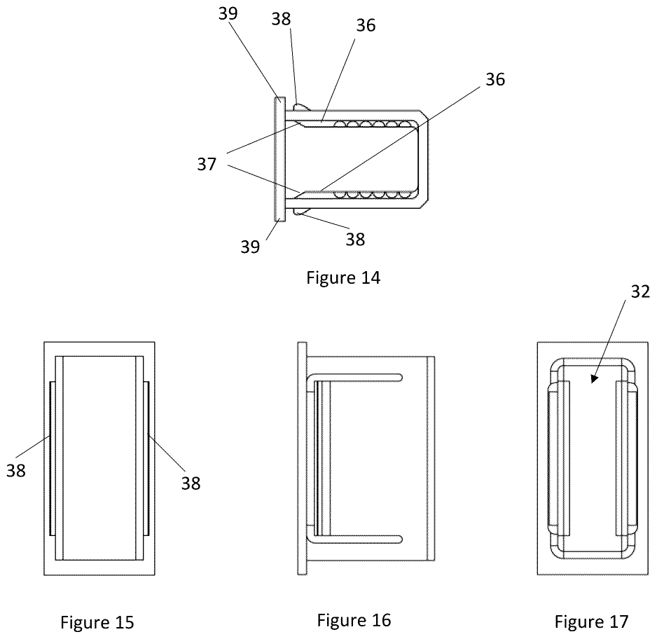

In the embodiment of the drawings, the female securing formations 33 are a first series of securing channels 33 formed on a first internal wall 34 of the female attachment member and a second series of securing channels 33 formed on a second internal wall 35 of the female attachment member. As can be best seen in FIGS. 12 and 13, the first series of channels 33 is located on an upper internal surface 34 of the cavity 32 and the second series of channels 33 is located on the lower internal surface 35 of the cavity 32, the upper surface 34 opposing the lower surface 35. The at least one male securing formation 29 comprises first and second projections 29, one formed on each of the flanges 25, 26 of the male attachment member 24. The projections of the male attachment member 24 is receivable into one of the securing channels 33 and the particular securing channel 33 the projections are received into is dictated by how far depthwise the blind rail 16 is pushed towards the attachment guide 13. The first projection 29 is located on the first flange 25 of the male attachment member 24 and, in use when inserted into the cavity 32 of the insert 12 of the female attachment member 12, the first projection faces upwards and engages with the first series of channels 33 formed on the upper internal surface 34 of the cavity 35 of the blind rail 16, and therefore associated cavity 32, is moved towards the attachment guide 13 and the flanges 25, 26 of the male attachment member 24 travel further into said cavity 32. Upon the blind rail 16 engaging with the frame of the window, no further travel of the blind rail 16 towards the window is possible and the first projection 29 settles into and is secured within whichever channel 33 it is located within at that point. A mirrored situation occurs between the second series of channels 33 on the lower internal surface of the cavity 32 and the second projection 29 on the second flange 26. The second projection 29 is located on the second flange 26 of the male attachment member 24 and, in use when inserted into the cavity 32 of the insert 12 of the female attachment member 12, the second projection faces downwards and engages with the second series of channels 33 formed on the lower internal surface 35 of the cavity 35 as the blind 16, and therefore associated cavity 32, is moved towards the attachment guide 13 and the flanges 25, 26 of the male attachment member 24 travel further into said cavity 32. Upon the blind rail 16 engaging with the frame of the window, no further travel of the blind rail 16 towards the window is possible and the second projection 29 settles into and is secured within whichever channel 33 it is located within at that point. The first and second series of channels 33 are each situated in or on their own respective raised and ramped sections 36 comprising ramps 37 located at the forward end of the cavity 32. However, it should be understood that the channels 33 may also be formed directly in the wall of the cavity 32. It should also be understood that the female securing formations need not necessarily take the form of channels, for example a series of ridges or stops may be provided, the male securing formations passing over the ridges or stops to settle between two adjacent ridges or stops. In general, the securing features 28, 29 can take the form of any features which may secure or partially secure the blind rail and guide relative to each other at a plurality of depthwise locations, the skilled person being capable of forming such an engagement in various different ways and understanding all such ways to fall within the scope of the presently claimed invention. The flanges 25, 26 are resilient flanges which are sized such that, when inserted into the cavity, the projections 29 thereof contact the ramp and are forced inwardly towards each other, increasing the friction between the raised and ramped sections 36 and the flange projections 29 as the flanges flex and apply a force to the raised and ramped sections 36. This force causes the projections to seat in each channel 33 as said projection travels inwardly of the cavity 32, the blind having to be forced to an extend to unseat from each channel 33 and travel to the next depthwise channel 33.

Likewise, once the projections 29 are seated in a channel, a force is required to reverse the movement of the blind rail 16 in a direction to remove the flanges 25, 26 from the cavity 32. This encourages the projection 29 to be retained in a channel and the blind rail 16 to remain in position until it is desired to either move the blind rail 16 further towards the attachment guide 13 and force the projection to the next depthwise channel, or to remove the blind rail 16 from the attachment guide 13. This results in an adjustable arrangement that can compensate for windows where the glazing is set-back from the frame at differing depths, and negates the need to require customers ordering a bespoke blinds to measure glazing set-back, and for the manufacturer to specifically manufacture for a given set-back.

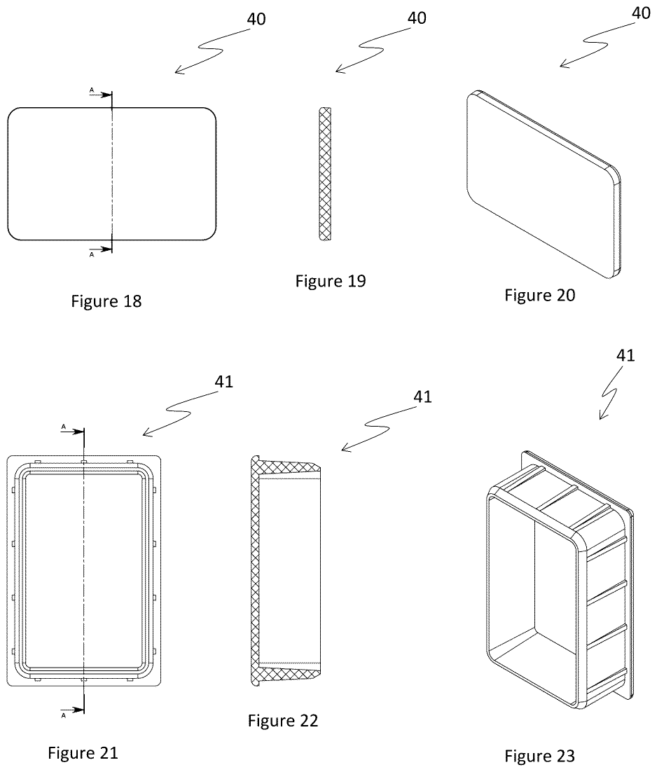

As can be seen best in FIGS. 18 to 20, a closure cap 40 is provided on the open top end 42 of the guide-side attachment feature 11. End caps 41 are also provided to close the open ends of the end guide sections.

In an example of use, a blind rail is manufactured with one blind-side attachment feature 12 being installed a predetermined distance from each of the vertical outside edges of the blind rail 16. This is done by forming an aperture in the blind rail 16 and inserting the insert 12 thereinto at the predetermined location. The guide-side attachment features 11 are then each attached to predetermined respective end guide sections and a common central guide section is then cut or chosen depending on the width of the glazing the attachment guide 13 is to be attached to, said with generally being supplied by an end customer when ordering a blind. The common central guide section is then joined between the two guide-side attachment features 11 to their ends opposing the ends attached to their respective end guide sections. The blind rail 16 and attachment arrangement may then be delivered to the end customer for installation, or can be installed professionally if desired. For installation, one of the two attachment guide 13 is adhesively attached generally horizontally along the top portion of the glazing. The blind rail 16 is then orientated such that the guide-side and blind-side attachment formations 11, 12 align, and the blind rail 16 is pushed towards the attachment guide 13. As the blind rail 16 is pushed, the guide-side attachment features 11 become at least partially inserted in the cavities 32 of the inserts 12 and the corresponding securing features 28 engage. When the blind rail 16 is pushed to an extent wherein it contacts at least a portion of the window frame 43, the projections 29 seat in a channel 33 in the above described manner, releasably securing the blind rail and any associated blind to the window frame via the attachment guide.

The invention is not limited to the embodiment(s) described herein but can be amended or modified without departing from the scope of the present invention.

1. A blind attachment arrangement comprising:
at least one attachment guide adhesively attachable to a window, door, or the like;
at least one guide-side attachment means associated with the attachment guide;
at least one blind-side attachment means associated with a blind;
wherein the at least one guide-side and blind-side attachment means are corresponding attachment means sized, dimensioned, and positioned to selectably engage one another to form an attachment therebetween and resultantly secure a blind to a window, door, or the like, wherein the blind attachment arrangement comprises a depth adjustment mechanism disposed between the attachment guide and blind configured such that one of the attachment guide or blind is securable relative to the respective other of the attachment guide or blind at a plurality of depthwise locations.

2. The blind attachment arrangement of claim 1, wherein the attachment guide and blind comprise corresponding securing features disposed therebetween, said securing features being configured such that one of the attachment guide or blind is securable relative to the respective other of the attachment guide or blind at a plurality of depthwise locations.

3. The blind attachment arrangement of claim 1, wherein the attachment guide is an elongate member comprising a first side configured for adhesive attachment to a window, door, or the like and a second side comprising the at least one guide-side attachment means.

4. The blind attachment arrangement of claim 3, wherein the attachment guide is an elongate member sized to extend all or part way across the window door, or the like in a generally horizontal manner, and where preferably the attachment guide is sized to extend substantially all the way across the window door, or the like in a generally horizontal manner.

5. The blind attachment arrangement of claim 1, comprising at least two attachment guides, one attachment guide being locatable at or about a top end of a window door, or the like and one attachment guide being locatable at or about a bottom end of said window door, or the like.

6. The blind attachment arrangement of claim 5, wherein the at least one guide-side attachment means is formed integrally with, is attachable to, or is configured to form part of the at least one first attachment guide.

7. The blind attachment arrangement of claim 6, wherein the at least one attachment guide is a multi-section elongate attachment guide comprising a plurality of guide sections, said guide sections being attachable to each other and/or to the at least one guide-side attachment means to form the attachment guide.

8. The blind attachment arrangement of claim 7, wherein the at least one guide-side attachment means comprises a guide-side section attachment portion which is attachable to one or more guide sections in an end to end arrangement such that a plurality of guide sections and at least one guide-side attachment portion are attachable sequentially in a linear arrangement to form an elongate attachment guide.

9. The blind attachment arrangement of claim 8, wherein first and second guide-side attachment portions are provided and the attachment guide comprises, in sequential order, a first guide section, the first guide-side attachment portion, a second guide section, the second guide-side attachment portion, and a third guide section attached together in a linear arrangement such that a guide arrangement comprising two spaced apart guide-side attachment portions is formed.

10. The blind attachment arrangement of claim 9, wherein one of the guide-side attachment means or the blind-side attachment means comprises a male attachment member and the other of the guide-side attachment means or the blind-side attachment means comprises a corresponding female attachment member configured to receive the male attachment member.

11. The blind attachment arrangement of claim 10, wherein the guide-side attachment means comprises a male attachment member which protrudes from the guide-side attachment means in a direction away from a blind facing surface of the attachment guide, the blind facing surface being the surface opposing a surface of the attachment guide attached to a window door, or the like when in use.

12. The blind attachment arrangement of claim 10, wherein the male attachment member comprises at least one engagement flange which projects, in use, away from the attachment guide and window door, or the like to which said attachment guide is attached, and preferably where the male attachment member comprises two such flanges.

13. The blind attachment arrangement of claim 11, wherein the guide-side attachment means comprises first and second attachment guide engagement portions configured to connect the guide-side attachment means between two sections of the attachment guide in a liner fashion, and the male attachment member extends generally perpendicular to the attachment guide engagement portions.

14. The blind attachment arrangement of claim 1, wherein the at least one blind-side attachment means is formed integrally with, is attachable to, or is configured to form part of a blind, and preferably is formed integrally with, is attachable to, or is configured to form part of a blind rail, and optionally
wherein the at least one blind-side attachment means comprises a blind attachment portion comprising a female attachment member formed for receiving at least a portion of the male attachment member of the guide attachment means, and optionally
wherein the female attachment member comprises a cavity into which at least a portion of the male attachment member is receivable, and optionally
wherein the blind-side attachment means comprises an insert member formed for insertion into an aperture formed in a window door, or the like facing surface of a blind or blind rail, said insert member defining a cavity therein which extends inwardly, into the blind or blind rail from the window door, or the like facing surface of the blind, said cavity being sized, dimensioned, and positioned to receive at least a portion of the male attachment member.

15. The blind attachment arrangement of claim 11, wherein securing features are disposed between the male and female attachment members such that the male attachment member is insertable into and securable relative to the female attachment means at a plurality of depthwise locations.

16. The blind attachment arrangement of claim 14, wherein the securing features are corresponding securing features, at least one of the male or female engagement members having a series of increasingly depthwise dispersed securing features and the respective other of the male or female engagement members having at least one securing feature sized and dimensioned for releasable securing in one of said depthwise dispersed securing features, and optionally
wherein the corresponding securing features comprise at least one series of female securing features having a plurality of female receiving formations locatable on the blind attachment means, each said formation being located in a progressively depthwise manner; and at least one male securing formation locatable on the guide attachment means formed for selectable receipt into one of the female receiving formations.

17. The blind attachment arrangement of claim 16 when dependent on claim 14, wherein the female securing formations are a series of securing indentations or channels formed on an internal wall of the female attachment member, the at least one male securing formation being a projection formed on the male attachment member, and preferably on the at least one flange of the male attachment member, the projection being received into one of the securing channels, the particular securing channel the projection is received into being dictated by how far depthwise the blind is pushed towards the attachment guide, and optionally
wherein a first series of female securing channels is formed on a first internal wall of the cavity and a second series of female receiving channels is formed on a second internal wall of said cavity opposing said first wall thereof, and wherein the male attachment member comprises first and second projections, the first projection being located on a first flange of the male attachment member such that said first projection faces the first series of female securing channels when the guide-side and blind-side attachment are engaged, and the second projection being located on a first flange of the male attachment member such that said second projection faces the second series of female securing channels when the guide-side and blind-side attachment are engaged, the projections being configured to engage said respective channels as the male attachment member is inserted into the cavity.

18. The blind attachment arrangement of claim 1, wherein the at least one attachment guide is adhesively attachable to a window, door, or the like and is not required to extend behind beading or any other such glass retention feature in order to provide a secure attachment which permits a blind to be installed thereto, and preferably wherein the at least one attachment guide is adhesively attachable to the glazing portion of a window, door, or the like.

19. A blind assembly comprising a blind and a blind attachment arrangement, the blind attachment arrangement comprising:
at least one attachment guide adhesively attachable to a window, door, or the like;
at least one guide-side attachment means associated with the attachment guide;
at least one blind-side attachment means associated with the blind;
wherein the at least one guide-side and blind-side attachment means are corresponding attachment means sized, dimensioned, and positioned to selectably engage one another to form an attachment therebetween and resultantly secure the blind to a window door, or the like, wherein the blind attachment arrangement comprises a depth adjustment mechanism disposed between the attachment guide and blind configured such that one of the attachment guide or blind is securable relative to the respective other of the attachment guide or blind at a plurality of depthwise locations.

20. A method of manufacturing a blind assembly comprising the steps of:
providing at least one attachment guide adhesively attachable to a window, door, or the like and sizing said attachment guide to fit said window, door, or the like;
forming at least one guide-side attachment means associated with the attachment guide;
forming at least one blind-side attachment means associated with the blind;
wherein the at least one guide-side and blind-side attachment means are corresponding attachment means sized, dimensioned, and positioned to selectably engage one another to form an attachment therebetween and resultantly secure the blind to a window door, or the like, wherein the blind attachment arrangement comprises a depth adjustment mechanism disposed between the attachment guide and blind configured such that one of the attachment guide or blind is securable relative to the respective other of the attachment guide or blind at a plurality of depthwise locations.
